(19) United States
(12) Patent Application Publication
(10) Pub. No.: US 2002/0194083 A1
(43) Pub. Date: Dec. 19, 2002

(54) System and method for network service provisioning

(76) Inventors: Srinivas Balabhadrapatruni, Westford, MA (US); Srinivas Loke, Westford, MA (US); Prasad Dorbala, Lexington, MA (US); Satish L. Yellanki, Lowell, MA (US); Sunil K. Kotagiri, Lowell, MA (US); Sitaram Dikshitulu, Westford, MA (US); Deepika Gupta, Acton, MA (US); De Quan Wu, Nashua, NH (US); Ravi S. Kumar, Shrewsbury, MA (US); Kishore R. Ramasayam, Lowell, MA (US); Vikram Saksena, Acton, MA (US); Prashant Saxena, Nashua, NH (US); Radu Craioveanu, Hooksett, NH (US); Dinesh Lokhande, Marlboro, NJ (US); Zhenyu Li, Acton, MA (US); Subrahmanyam Dravida, Shrewsbury, MA (US); Dev V. Gupta, Concord, MA (US); David A. O'Hare, Nashua, NH (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/142,728

(22) Filed: May 8, 2002

Related U.S. Application Data
(60) Provisional application No. 60/289,618, filed on May 8, 2001.

(51) Int. Cl. G06F 17/60

(52) U.S. Cl. 705/26

(57) ABSTRACT

In a computer network, services are provisioned for a user over the network, typically via a series of messages. Depending on the particular service to be provisioned many network entities may be concerned with the provision of a particular service. However, an initiator of a service request may be unaware of all the network entities concerned with a service provision request. A system which receives a single request for service provisioning from an initiator, determines each network entity corresponding to the request from a common repository of network entities, and applies the operations concerned with the service provision request at each corresponding network entity, allows a service to be provisioned without manually searching and examining the network to determine the network entities concerned with a particular service provision request. The system thereby alleviates manual application of the service provisioning request at each of the network entities, allowing a single discrete command, such as a mouse click, to provision the service.

### RELATED APPLICATION

This Application claims the benefit of U.S. Provisional Application No. 60/289,618, filed on May 8, 2001, entitled “System and Method for Network Service Provisioning,” (Attorney's Docket No. 3070.1003-000). The entire teachings of the above application are incorporated herein by reference.

### BACKGROUND OF THE INVENTION

In a computer network, services are provided to a user via a remote server node operable to provide such services. The services are provided over the network, typically via a series of messages. Depending on the particular service to be provided, many messages and network elements may be concerned with the provision and subsequent delivery of a particular service. However, an initiator of a service provisioning request, such as a manual operator or an automated control thread, may be unaware of all the network elements or entities concerned with a particular service provision request. Further, even if the initiator is aware, not all of the network elements concerned may be addressable from the point of the service provision. Some of the network elements may be passive, and unable to communicate via the network. Other network elements may be inaccessible due to an inability to determine the identity or location of the particular network element. Still others may be temporarily inaccessible from failure of intermediate network elements.

### SUMMARY OF THE INVENTION

In a computer network, services are provisioned from servers to users. In delivering the service, a plurality of network entities may be involved. The network entities may include network elements such as switches, routers and taps, configuration files applicable to the network elements, service plans expressed as templates for a particular service, and other network devices and files associated with provisioning a service. Before a service is usable by a user, the service needs to be provisioned. Provisioning a service (service provisioning) includes identifying all network entities responsible for delivering the service. Service characteristics of each identified network entity are determined, and are then set accordingly such that the service itself may be delivered to the user on a demand basis.

A system and method for service provisioning in a computer network which receives a single request for service provisioning from an initiator, such as a client, determines each network entity corresponding to the request, and applies the operations concerned with the service provisioning request at each network entity. Service characteristics corresponding to each network entity are registered in a common repository. The requested service is provisioned by retrieving the service characteristics from the common repository, to avoid manually searching and examining the network to determine the network entities concerned with the particular service provision request. The system thereby alleviates manual application of the service provisioning request at each of the network entities concerned.

The service characteristics are defined, or encapsulated, as a task definition in an executable script file. The executable scripts may be, for example, as defined in copending U.S. Patent application, entitled “Language and Interface for Unified Network Service Creation, Provision and Deployment,” (Attorney's Docket No. 3070.1007-000), assigned to the assignee of the present application and incorporated herein by reference. Provisioning the service involves executing the sequence of task definitions associated with the service, such as by applying service parameters for each of the determined service characteristics. Further, a task definition may include external events. External events correspond to service parameters which may not be resolved directly by the service manager, and may include network elements which are not yet installed, or those not directly addressable by the service manager (external entities). For example, a new user requesting a VOIP (Voice Over IP) or Internet service may not yet have an adequate coaxial line installed. External events require manual intervention, such as by an human operator, to resolve. An external event is generated indicating a condition which must be satisfied in order for the service provisioning to continue. After the condition is satisfied, such as by installation or manual configuration of the network element, a completion event is generated, indicating satisfaction of the condition and allowing completion of the service provisioning request.

The common repository is a mass storage element or network node, accessible across the network, such as an LDAP (Lightweight Directory Access Protocol, RFC 1777) directory or other storage element accessible via a common protocol. The use of a common protocol allows consolidation of all information required for provisioning the service such that a single service provisioning request can initiate a complete service provisioning task for a user. The network may be, for example, a TCP/IP compliant network in which the network entities are SNMP (Simple Network Management Protocol) compliant.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a computer network for service provisioning as defined herein;

FIG. 2 is a block diagram of the service provisioning system;

FIG. 3 shows network entities concerned with provisioning the services;

FIG. 4 is a block diagram of the service provisioning system in more detail;

FIG. 5 is a flowchart of network service provisioning;

FIG. 6 is a diagram of the common repository for service provisioning characteristics;

FIG. 7 shows the interface between the service manager and network management system in more detail;

FIG. 8 shows the service manager interconnected with a plurality of Local Broadband Access Networks; and

FIG. 9 shows multiple network management systems employed in a service provisioning request.

### DETAILED DESCRIPTION OF THE INVENTION

A description of preferred embodiments of the invention follows.

The method for service provisioning via a network as defined herein in which a particular service employs multiple network entities allows a single user directive, or instruction such as a point-and-click selection, to initiate the service provisioning for all of the network entities concerned. A service manager defines a plurality of network entities, each of the network entities having service characteristics, and registers each network entity and associated service characteristics in a common repository, such as an LDAP directory. A service is selected by a user, or client, to be provisioned. The service manager, which includes a service provisioning server and service mediation server, determines the network entities corresponding to the service to be provisioned, and retrieves the service characteristics of the corresponding network entities from the common repository. The service characteristics are then applied to each of the corresponding network entities as determined via the common repository, commenced from the single user directive, or instruction.

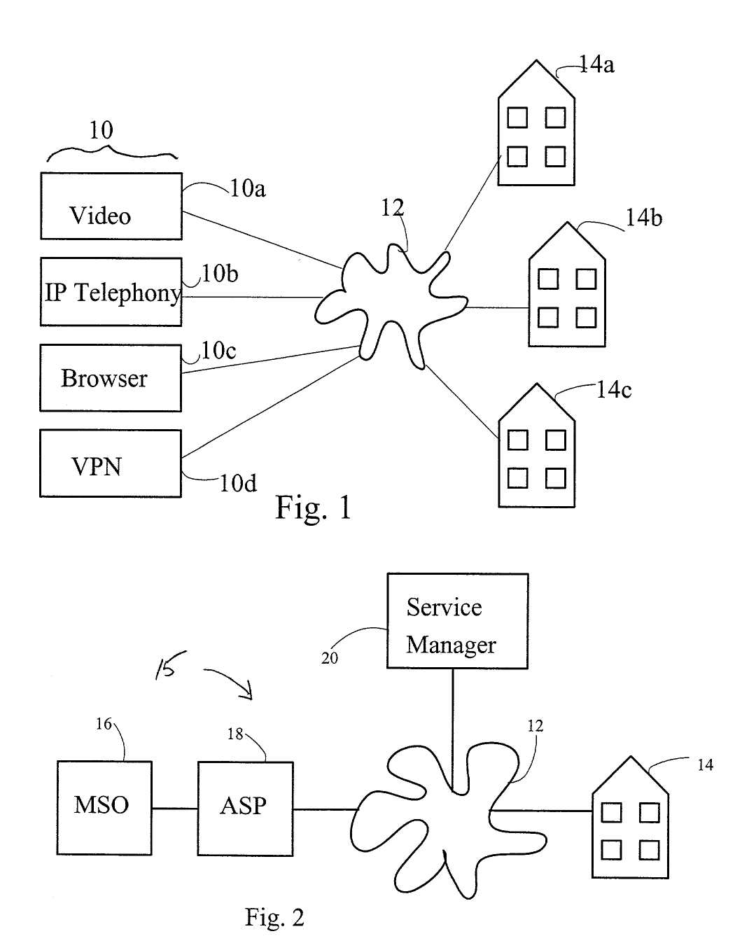

The computer network is employed for provisioning, and subsequently delivering, services to users. Services are provisioned through a service provisioning system via the network as described below, and are subsequently provided, or invoked, for the particular user. FIG. 1 shows a context diagram of the present invention. Referring to FIG. 1, a plurality of services 10 are available for provisioning to users 14a-14c via a network 12. The users 14a-14c are shown as exemplary. An arbitrary plurality 14a-14n of users can be supported, depending on available resources. The network 12 may include a public access network such as the Internet and other networks and/or subnetworks, such as hybrid fiber-coax networks, described further below. The exemplary services include video 10a, such as pay-per-view, video on demand, and digital cable; IP telephony 10b, such as voice-over-IP (VOIP) and digital telephones; Internet access via a web browser 10c, and Virtual Private Networks (VPN) 10d. Other services can be similarly provisioned.

FIG. 2 is a block diagram of the service provisioning system 15. Referring to FIG. 2, a Multiple System Operator (MSO) 16 deploys services on a fee basis via the network 12, typically on a large scale (national) basis. The MSOs 16 typically employ local Application Service Providers (ASPs) 18, such as a local cable provider, distributed geographically adjacent to the users 14 which receive the services 10. The service manager 20 is connected to the network 12 for provisioning the service 10 for each user 14. The network 12 includes network entities, described further below, which are activated by the service manager 20 to provision the service. Once provisioned, the service may be delivered (invoked) to the user on a demand basis by the user, such as by turning on a PC, telephone, or activating the service via a TV remote or mouse click. Note that provisioning the service includes initializing the network entities concerned with the service to such a state that the service may then be delivered to a user on demand, without additional setup steps involving data entry, operator intervention, or additional device configuration. In this manner a provisioned service may be delivered to a user in response to a single discrete directive.

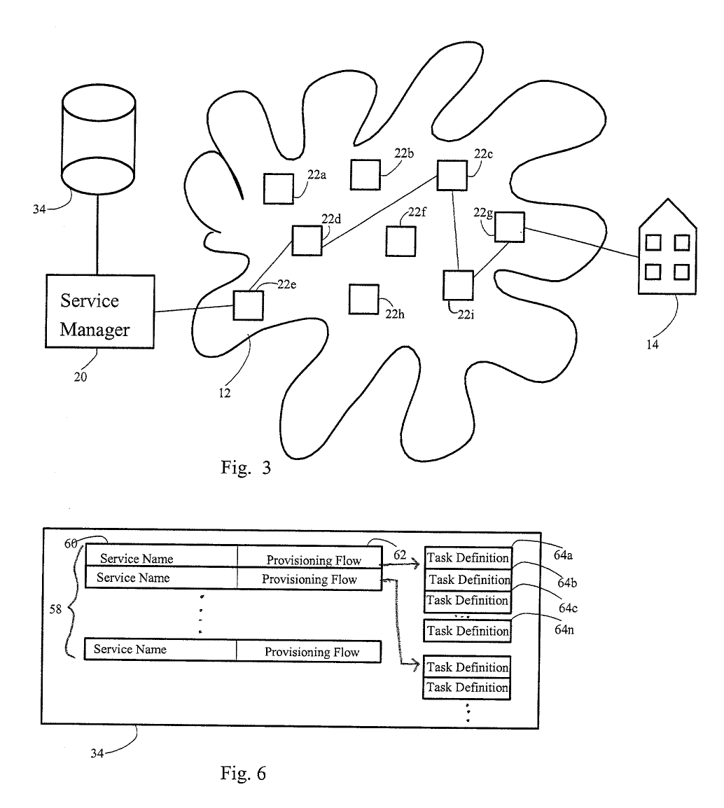

FIG. 3 shows network entities concerned with provisioning the services. Referring to FIG. 3 and again to FIG. 1, the network 12 includes a plurality of network entities 22a-22i. Provisioning the service 10 involves provisioning one or more of the network entities (22 generally) concerned with providing the service 10. As described above, network entities 22 may include network elements, such as hardware devices, configuration files which describe how to deliver the service, or service plan files which describe a particular instantiation of the service. The identity of network entities 22 concerned with a particular service 10 are stored in a common repository 34 described further below, referenced by a corresponding service name. When a particular service 10 is to be provisioned, the common repository 34 is referenced using the service name to determine the network entities 22 to be provisioned. For each network entity 22, a task definition in the form of an executable script is stored in the common repository. The task definition is indicative of service parameters, described further below, employed for the network entity 22 to deliver the particular service 10. Therefore, the service manager 20 may reference the common repository 34 using the service name 10 (service) and may determine all network entities 22 and the associated service parameters required to provision the service.

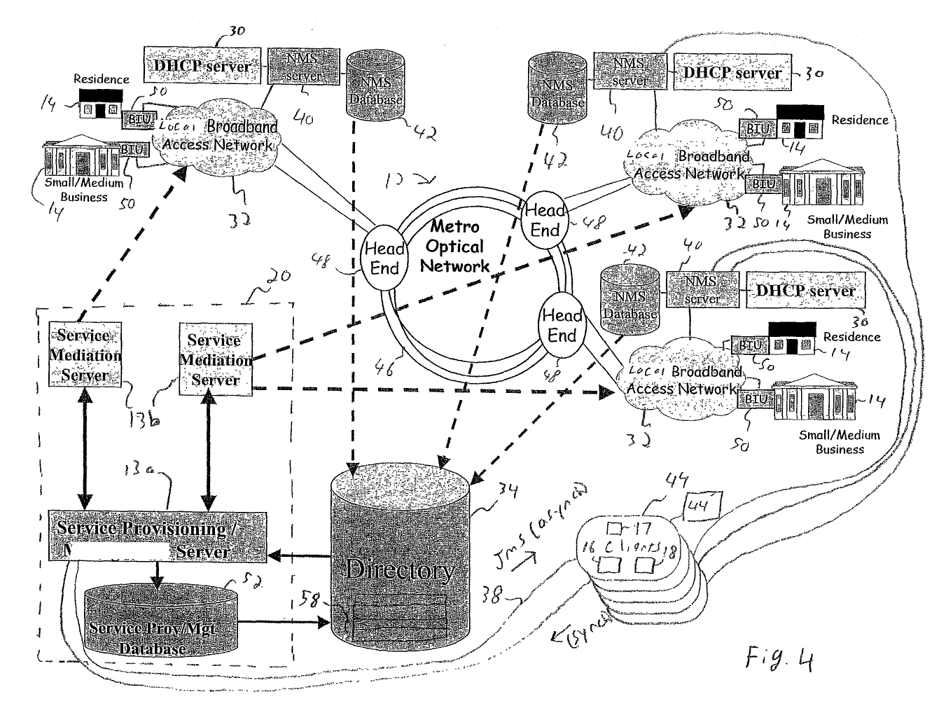

FIG. 4 is a block diagram of the service provisioning system 15 in more detail. Referring to FIG. 4, the network 12 further comprises a metro area network 46, which may be part of a larger wide area network (WAN), not shown, and includes subnetworks called Local Broadband Access Networks (LBANs) 32. Each of the LBANs 32 is connected to the metro area network 46 via an optical headend 48. While fully interconnected as part of the network 12, the LBANs 32, described further below, exploit certain properties via intelligent network elements on a hybrid fiber-coax subnetwork, as disclosed in copending U.S. patent application Ser. No. 09/952,482, entitled “Network Architecture for Intelligent Network Elements,” filed Sep. 13, 2001 (Atty. Docket No. 3070.1000-003), incorporated herein by reference.

The users 14, such as residences and small/medium sized businesses, are connected to the LBANs 32 via a business interface unit 50 (BIU). Each business interface unit 50 is a network entity 22 which may be provisioned as part of service provisioning as defined herein. A network management server (NMS) 40 is connected to each LBAN 32 to facilitate network level connections between the LBAN and the users 14 connected to the LBAN 32.

The NMS provides network support associated with service provisioning. The NMS binds a particular customer site, or BIU 50, to an LBAN, such as via a DHCP server 30 for allocating IP addresses to users 14 and BIUs 50 as they sign on. The NMS also performs alarm correlation by receiving alarms, along with the service provisioning engine, for identifying affected services and users.

The service manager 20 is in communication with the common repository 34, and with each of the LBANs 32. The service manager 20 includes a service provisioning server 13a and a plurality of service mediation servers 13b. Each of the service mediation servers 13b is connected to one or more LBANs 32 for provisioning network entities within that LBAN 32. The service provisioning server 13a receives a request to provision a service from a client 44, and retrieves the task definitions from the common repository 34 containing the corresponding service characteristics for the selected service 10. A service provisioning management database 52 stores information about the service mediation servers and the LBANs 32 that they are connected to. Employing the task definitions and the information from the service provisioning management database 52, the service provisioning server 13a identifies the service mediation server 13b connected to the LBANs 32 having the corresponding network entities 22, and directs the applicable service mediation servers 13b to provision the network entities 22.

The services 10 are provisioned on behalf of the MSOs 16 and ASPs 18 from which the service originates. The MSOs 16 and the ASPs 18, therefore, comprise clients 44 for whom the service is provisioned. Once provisioned, the service is actually invoked, or delivered, via the LBAN 32 from the service provider, described further below. Further, the provisioning may be initiated from a Network Operations Center (NOC) 17, acting on behalf of the service provider, or may be invoked by direct input from the user 14, through a graphical user interface (GUI) 44′ such as a web browser.

The services 10 are provisioned by applying the service characteristics retrieved from the common repository to the network entities 22. Once provisioned, as indicated above, the service may be utilized by the user, or invoked, by a single instruction (action), such as turning on a telephone or PC, or activation via a TV remote. The provisioned service, when invoked, is provided in conjunction with the local NMS server 40 corresponding to the LBAN 32 to which the user 14 is connected. The NMS 40, which stores user 14 specific data in a corresponding NMS database 42, is also in communication with the common repository 34 for service provisioning, and has access to the associated task definitions (scripts) and other information therein.

The NMS 40 operates in parallel with the delivery of provisioned services by maintaining operation of the network elements responsible for providing the service. Typical heterogeneous systems include multiple elements with varying degrees of interoperability. Effects of a network element failure may not be readily diagnosed or identified with respect to the services and or users concerned. The NMS 40 provides a homogeneous network which is proactively aware of users and services affected by a network element failure by intercepting alarms and correlating with the NMS database 42.

As network elements such as BUIs 50 serving the users 14 sign onto the network, they are provided a network address such as an IP address via a hardcoded address, a DHCP server 30, or other means. The service characteristics having the users address and identity are written to the common repository 34 such as an LDAP directory. The LDAP directory allows the service manager 20 to retrieve the identity and network address of each of the network elements 50 concerned with the provisioning of a service 10. Due to the distributed nature of the LDAP directory, an LDAP lookup operation will allow the service characteristics of the concerned network entities 22 to be retrieved from the initiating client.

The service provisioning server 13a is adapted to correspond to a plurality of service mediation servers 13b. Each of the service mediation servers 13b may correspond to a Network Management Servers (NMS) 14. Each of the clients 16 is in communication with the NMS 40 and the service manager 20 via an asynchronous Java Messaging Service (JMS) interface 38 which allows proactive, realtime updates, such as creation and modification of users and services, thereby avoiding manual requests for updates. As noted above, the clients 44 as shown herein may be ASP 18 or MSO 16 clients, such as operators at a Network Operations Center (NOC) 17, web portal clients 44′ having access via the network 12, or other user interface employed to request provisioning of services.

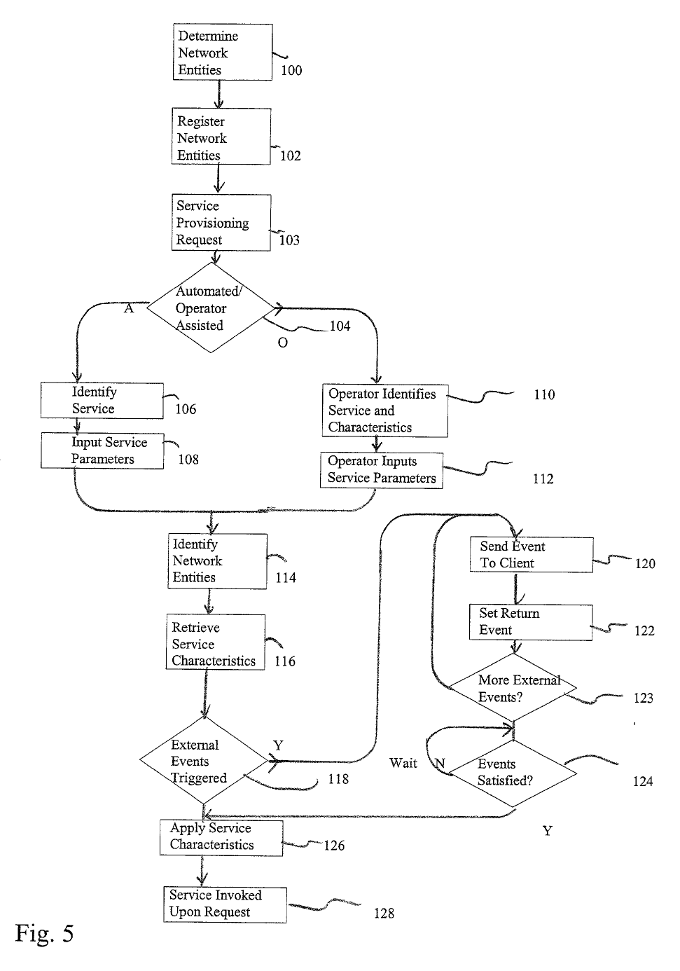

FIG. 5 is a flowchart of network service provisioning as defined herein. Referring to FIGS. 4 and 5, the available network entities are determined, as shown at step 100. Available network entities are defined at network installation, and are further defined in an ongoing manner as new entities are added to the network. The service characteristics of the defined network entities are registered with the common repository, as shown at step 102. The service characteristics include service fields which may be populated with user specific service parameters or fixed parameters applicable to a particular service. A user requests a new service to be provisioned, as depicted at step 103. A check is performed to determine if the user is requesting the service through an automated client 44′ (i.e. web driven GUI) or via an operator assisted transaction via a voice phone, as shown at step 104. An operator assisted transaction is typically performed at a network operations center (NOC) operated on behalf of the client 44.

If the user is requesting the service through an automated interface, then the relevant service is identified along with relevant service characteristics, as shown at step 106. The relevant service and service characteristics may be identified as a network entity 22 in the common repository 34, or may be stored locally in the service provisioning database 52. The applicable service parameters gathered (input) from the user via the GUI, as depicted at step 108. If the user is requesting the service through an operator assisted client 44, then the operator identifies the relevant service and service characteristics, as shown at step 110. Again, the service and service characteristics may be stored as a network entity 22 in the common repository 34 or stored locally in the service provisioning database 52. The operator then inputs the applicable service parameters based on user input, as described at step 112.

The network entities 22 corresponding to the identified service are then determined from the identified service by querying the common repository, as depicted at step 114. The service characteristics for each of the network entities 22 is retrieved from the common repository, as shown at step 116. A check is performed to determine if any external events are to be triggered to provision the service, as disclosed at step 118. An external event is triggered if a manual intervention by an operator is required to complete the service provisioning. Such an external event might be, for example, a network device that was not yet installed, or for an external entity such as a vendor supplied hardware element not addressable by the service manager 20 and which required manual configuration. If an external event is triggered, it is sent to the applicable client for action, such as to an ASP 18 for operator action, as depicted at step 120. A return event indicative of correction of the condition which triggered the event is set, as shown at step 122. A check is performed to determine if there are any more external events, as shown at step 122. If there are more external events, control reverts to step 120. If all external events have been sent, control returns following step 118.

A check is performed to determine if all outstanding return events have been satisfied (received), as shown at step 124. If there are outstanding conditions for which a return event indicating satisfaction of the condition have not yet been received, then service provisioning waits for the outstanding return event. If all outstanding events have been satisfied, or if there were no external events triggered for this service provisioning, then the service characteristics are applied to the determined network entities 22 as disclosed at step 126. Once provisioned, the service may be invoked upon user request, as shown at step 128.

FIG. 6 is a diagram of the common repository 34 for service provisioning characteristics. Referring to FIG. 6, the common repository 34 includes a plurality of service entries 58 indexed by service name 60. Each service name 60 has a service provisioning flow 62, which indexes to one or more task definitions 64a-64n for provisioning the service. Each of the task definitions 64a-64n contains the service characteristics for a particular network entity 22. Therefore, the service manager 20 may reference the common repository 34 by service name 60, and retrieve the network entities and associated service characteristics for provisioning the service.

As indicated above, in a particular embodiment, the common repository 34 is an LDAP (Lightweight Directory Access Protocol) directory. The use of an LDAP directory allows distributed population and access by the service manager 20, including the service provisioning server 13a and the service mediation servers 13b, which tend to be distributed depending on the deployment of the LBANs 32.

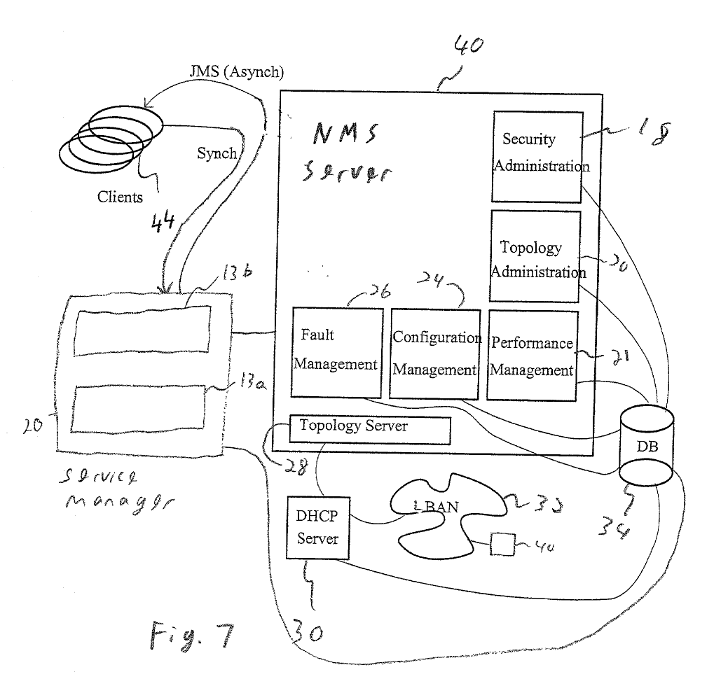

FIG. 7 shows the interface between the service manager and network management system 40 in more detail. The NMS 40 maintains network throughput for the users 14 connected to a particular LBAN by maintaining and diagnosing network element failures. Referring to FIG. 7, as network elements, such as business interface units 50 serving a user 14 sign on, a DHCP server 30 or other address allocation mechanism in communication with a topology server 28 allocates a network address for the network element. The identity and address information are sent to the common repository 34. Also in communication with the common repository 34 from the NMS 40 are a security administration server 18, a topology administration server 20, a performance management server 21, a configuration management server 24, and a fault management server 26. Each of these servers 18, 20, 21, 24, and 26 performs various operations and functions concerned with actually delivering the service to a particular user, and sends information to the common repository 34. Delivering the service includes data throughput for the service, initiation and termination such as setting up and tearing down connections, and diagnostic and fault reporting, as described in copending U.S. Provisional Application No. 60/289,618 cited above. In a particular embodiment, the fault management server 26 may be employed for fault correlation between a plurality of NMSs 50. The operations and functions may be according to a particular protocol, such as the Simple Network Management Protocol (SNMP) or other known standard.

When the service manager 20 receives an instruction to initiate a service request, each network entity concerned with delivering the service is determined from the common repository 34. The common repository 34 is then referenced to determine the address and identity of each network entity corresponding to the service, and the service is provisioned by performing the service operations at each of the network elements 22. In this manner, the use of an LDAP directory for the database 34 provides efficient remote access to the address and identity of each concerned network element.

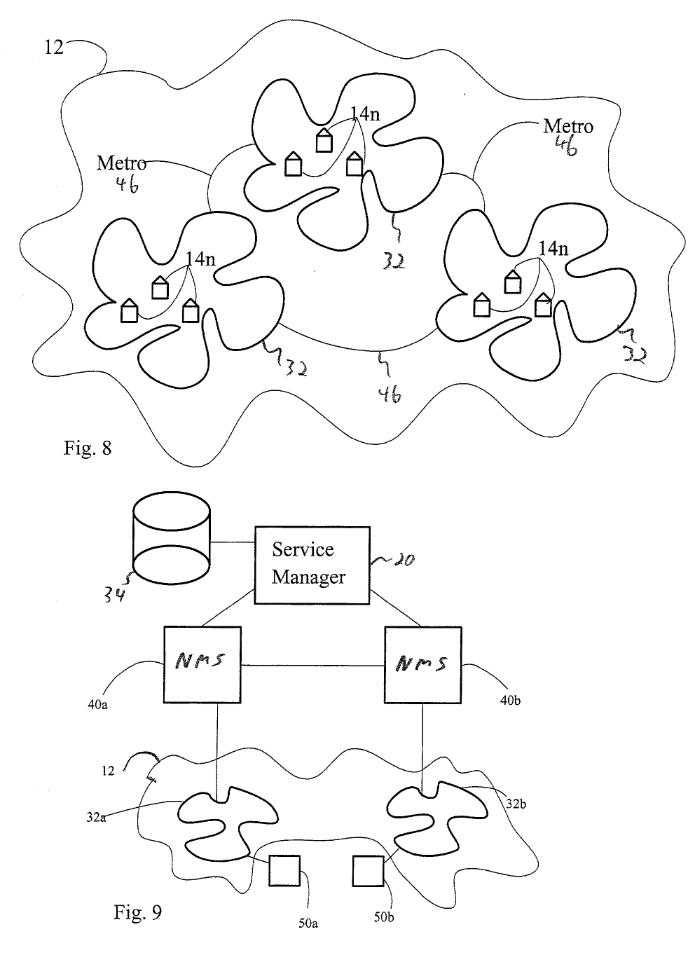

FIG. 8 shows distribution of the users 14a-14n across a plurality of LBANs 32 within the network 12. Referring to FIG. 8 and again to FIG. 4, a plurality of LBANs 32 are included within the network 12. The LBANs 32 are interconnected by a metro area network 46, which communicate via trunk or optical lines. Each LBAN 32 supports a plurality of users 14, as described above. Further, each of the network entities 22 within an LBAN 32 may be addressed by another LBAN 32 via the interconnection 46, as in the case where a service corresponds to multiple network entities in different LBANs 32.

FIG. 9 shows another embodiment including multiple NMSs corresponding to a service manager for the provision of a particular service to multiple users 50a, 50b. Referring to FIGS. 9 and 4, a plurality of LBANs 32a and 32b are each served by a respective NMS 40a and 40b. A particular implementation may have more LBANs 32 and NMSs 40. Typically each LBAN 32 has a particular NMS 40 generally. A service is selected for provisioning through a client 44, and a service request initiated. The service manager 20 identifies the network entities 22 concerned with the provision of this service. For example, the network entities 22 are computed to be a Business Interface Unit (BIU) 50a in Westford, on the LBAN 32a, and another BIU 50b in Andover, on the LBAN 32b. The service manager 20 accesses the common repository 34 to determine the identity and location of the BIUs 50a and 50b. The service manager 20 then communicates with the BIUs 36a and 36b via the corresponding service mediation server 13 to provision the service by applying the determined service parameters. In this manner, a single service provisioning initiated via the service manager 20 is applied to each network entity 22 concerned with delivering the service, without requiring manual lookups to determine the identity and location of the corresponding network elements, and without redundant requests for the service from each location, or LBAN 32, concerned.

Those skilled in the art should readily appreciate that the programs defining service provisioning as defined herein are deliverable to a service manager and associated network in many forms, including but not limited to a) information permanently stored on non-writeable storage media such as ROM devices, b) information alterably stored on writeable storage media such as floppy disks, magnetic tapes, CDs, RAM devices, and other magnetic and optical media, or c) information conveyed to a computer through communication media, for example using baseband signaling or broadband signaling techniques, as in an electronic network such as the Internet or telephone modem lines. The operations and methods may be implemented in a software executable by a processor or as a set of instructions embedded in a carrier wave. Alternatively, the operations and methods may be embodied in whole or in part using hardware components, such as Application Specific Integrated Circuits (ASICs), state machines, controllers or other hardware components or devices, or a combination of hardware, software, and firmware components.

While the system and method for service provisioning has been particularly shown and described with references to embodiments thereof, it will be understood by those skilled in the art that various changes in form and details may be made therein without departing from the scope of the invention encompassed by the appended claims. Accordingly, the present invention is not intended to be limited except by the following claims.

What is claimed is:

1. A method for provisioning services in a computer network comprising:
defining a plurality of network entities, each of the network entities having service characteristics corresponding to at least one service;
registering the service characteristics of the network entity with a common repository;
identifying a service to be provisioned over the network;
determining the network entities corresponding to the service to be provisioned;
retrieving the service characteristics for the determined network entities from the common repository; and
applying the service characteristics to the determined network entities.

2. The method of claim 1 further comprising receiving a request to provision a particular service.

3. The method of claim 1 wherein applying occurs automatically without operator intervention.

4. The method of claim 1 wherein the network entities further comprise network elements, configuration files, and service plans.

5. The method of claim 1 wherein registering further comprises encapsulating the characteristics as a task definition in a script file.

6. The method of claim 1 wherein retrieving the service characteristics further comprises retrieving service characteristics corresponding to all network entities concerned with provisioning the service.

7. The method of claim 1 wherein network entities are network elements and registering the service characteristics further comprises storing device characteristics operable for configuring the network element.

8. The method of claim 7 wherein the network elements comprise intelligent network elements.

9. The method of claim 1 wherein the common repository is an LDAP directory.

10. The method of claim 1 wherein identifying is a discrete operation operable to apply the provisioning of the service.

11. The method of claim 10 wherein the discrete operation is a one click GUI operation.

12. The method of claim 1 wherein determining the network entities further comprises determining external entities corresponding to an event.

13. The method of claim 12 wherein the external event includes a condition of the external entity to be satisfied by manual intervention.

14. The method of claim 13 wherein manual intervention includes operator intervention by a human operator.

15. The method of claim 13 further comprising generating a completion event corresponding to the satisfaction of the condition prior to applying the service characteristics.

16. The method of claim 1 wherein the service characteristics further comprise identity and location information.

17. The method of claim 1 wherein applying comprises applying to network entities at multiple remote sites.

18. The method of claim 1 wherein the computer network is an SNMP compliant network and the network entities are SNMP compliant.

19. A system for provisioning services in a computer network comprising:
a plurality of network entities, each of the network entities having service characteristics;
a common repository operable to store the service characteristics corresponding to each of the network entities;
a service manager operable to receive a request to provision a service, and further operable to identify each of the network entities corresponding to the service and to apply the service characteristics to each of the network entities, the common repository responsive to the service manager for retrieving the service characteristics of the network entities.

20. The system of claim 19 wherein the service manager is further operable to retrieve the service characteristics from a common repository according to the identified network entity.

21. The system of claim 19 wherein the network entities further comprise network elements, configuration files, and service plans.

22. The system of claim 19 wherein the service manager is further operable to retrieve the service characteristics and apply the service characteristics to the network entities automatically without operator intervention.

23. The system of claim 19 wherein the service characteristics further comprise a task definition encapsulated in a script file.

24. The system of claim 19 wherein the service manager is further operable to retrieve service characteristics corresponding to all network entities concerned with provisioning the service.

25. The system of claim 19 wherein network entities are network elements and the service characteristics further comprise device characteristics operable to configure the network element.

26. The system of claim 25 wherein the network elements comprise intelligent network elements.

27. The system of claim 19 wherein the common repository is an LDAP directory.

28. The system of claim 19 wherein the network entities further comprise external entities corresponding to an event.

29. The system of claim 28 wherein the event includes a condition of the external entity operable to be satisfied by manual intervention.

30. The system of claim 29 wherein manual intervention includes operator intervention by a network operator.

31. The system of claim 29 further comprising a completion event corresponding to the satisfaction of the condition prior to applying the service characteristics, wherein the service manager is responsive to the completion event.

32. The system of claim 19 wherein the service characteristics further comprise identity and location information.

33. The system of claim 19 wherein the service manager is further operable to apply the service characteristics to network entities at multiple remote sites.

34. The system of claim 19 wherein the network is an SNMP compliant network and the network elements are SNMP compliant.

35. A method for providing services in a computer network comprising:
selecting a service to be provisioned;
determining network elements corresponding to the service to be provisioned;
retrieving device characteristics of the corresponding network elements from a common repository; and
applying the device characteristics of the service at each of the corresponding network elements.

36. The method of claim 35 wherein the applying occurs automatically without operator intervention.

37. The method of claim 35 wherein the common repository is an LDAP directory.

38. The method of claim 35 wherein the services further comprise information retrieval services.

39. The method of claim 35 wherein selecting is a single operation operable to provision the service.

40. The method of claim 35 wherein the network elements are active.

41. The method of claim 35 wherein the device characteristics further comprise identity and location information.

42. The method of claim 35 wherein applying comprises executing at network elements at multiple remote sites.

43. The method of claim 35 wherein determining further comprises sending and receiving messages from a topology server.

44. The method of claim 35 wherein the network elements comprise intelligent network elements.

45. A system for providing services in a computer network comprising:
a plurality of network elements, each of the network elements having device characteristics;
a central repository operable to store the device characteristics corresponding to each of the network elements;
a service provisioning server operable to receive a request for a service and determine network elements corresponding to the service; and
a service mediation server operable to retrieve the device characteristics corresponding to the service from the central repository, and further operable to execute the service provisioning at each of the corresponding network elements.

46. The system of claim 45 wherein the service mediation server is operable to execute automatically without operator intervention.

47. The system of claim 45 wherein the central repository is an LDAP directory.

48. The system of claim 45 wherein the service provisioning server is further operable to apply the service at each network element from a single request.

49. The system of claim 45 wherein the network elements are active.

50. The system of claim 45 wherein the central repository is further operable to store device characteristics comprising identity and location information.

51. The system of claim 45 wherein the service mediation server is further operable to executing the service provisioning at multiple remote sites.

52. The system of claim 45 further comprising a topology server operable to send and receive messages indicative of the device characteristics.

53. The system of claim 45 wherein the network elements comprise intelligent network elements.

54. The system of claim 45 wherein the service provisioning server is further operable for integration with other services, wherein the integration provides event correlation between a plurality of servers affected by a particular event.

55. The system of claim 54 wherein the event correlation is fault correlation.

56. A computer program product including computer program code for provisioning services in a computer network comprising:
computer program code for defining a plurality of network entities, each of the network entities having service characteristics corresponding to at least one service;
computer program code for registering the service characteristics of the network entity with a common repository;
computer program code for identifying a service to be provisioned over the network;
computer program code for determining the network entities corresponding to the service to be provisioned;
computer program code for retrieving the service characteristics for the determined network entities from the common repository; and
computer program code for applying the service characteristics to the determined network entities.

57. A computer data signal including program code for provisioning services in a computer network comprising:
program code for defining a plurality of network entities, each of the network entities having service characteristics corresponding to at least one service;
program code for registering the service characteristics of the network entity with a common repository;
program code for identifying a service to be provisioned over the network;
program code for determining the network entities corresponding to the service to be provisioned;
program code for retrieving the service characteristics for the determined network entities from the common repository; and
program code for applying the service characteristics to the determined network entities.

58. A system for provisioning services in a computer network comprising:
means for defining a plurality of network entities, each of the network entities having service characteristics corresponding to at least one service;
means for registering the service characteristics of the network entity with a common repository;
means for identifying a service to be provisioned over the network;
means for determining the network entities corresponding to the service to be provisioned;
means for retrieving the service characteristics for the determined network entities from the common repository; and
means for applying the service characteristics to the determined network entities.
